(19) United States
(12) Patent Application Publication
(10) Pub. No.: US 2024/0109183 A1
(43) Pub. Date: Apr. 4, 2024

(54) HANDLING DEVICE

(71) Applicant: J. SCHMALZ GMBH, Glatten (DE)

(72) Inventors: Matthias FREY, Sulz-Dürrenmettstetten (DE); Jeremia SIPPLE, Glatten (DE)

(21) Appl. No.: 18/479,250

(22) Filed: Oct. 2, 2023

(30) Foreign Application Priority Data
Oct. 4, 2022 (DE) 10 2022 125 563.8

(51) Int. Cl. B25J 9/04; B25J 15/06

(52) U.S. Cl. CPC B25J 9/044; B25J 15/0616

(57) ABSTRACT

The invention relates to a handling device (10) comprising a manipulator (12) and a coupling device (16) having a coupling section (48) for coupling as end effector (14) to the manipulator, wherein manipulator comprises a spindle drive (20) for driving a translational and/or rotational movement of the coupling device with respect to a Z axis (24), wherein spindle drive comprises a spindle (22) extending along the Z axis, wherein the coupling section is adjustable with respect to at least one degree of freedom relative to the spindle, wherein a drive device (50) is provided for driving a positioning movement of the coupling section with respect to the at least one degree of freedom, wherein the drive device comprises a drive unit (52) and a force transmission device (54) for transmitting a driving movement of the drive unit to the coupling section, wherein the coupling device is arranged at a first end (26) of the spindle and wherein the drive unit is arranged at the second end (56) of the spindle.

The invention relates to a handling device comprising a manipulator, in particular a SCARA robot, and a coupling device for coupling an end effector to the manipulator.

Such handling devices are used, for example, when picking goods in warehouses, where they are used in particular to grip goods from a storage container having a plurality of goods (so-called “bin-picking”) and to move them to another location, for example, into a transport container.

In this connection, it is known to use robots with SCARA kinematics, wherein a translational and/or rotational movement along a Z axis is provided by a spindle drive, on the spindle of which the end effector is arranged. Such a robot with a spindle drive enables particularly rapid and repeatable movements and thus a high “gripping rate”.

In a typical application situation, a storage container mentioned above contains a large number of goods, which may also have different shapes, sizes and weights, for example. In particular, it is also conceivable that the objects lie in a disordered manner, i.e. with different orientations, in the storage container, and that the outer surface regions that are suitable for the gripping of different objects are oriented differently.

For safe grasping of an object, it is therefore regularly necessary to align the end effector depending on an external shape and/or orientation of an object to be gripped.

The invention deals with the task of being able to flexibly and rapidly grip objects with different orientations and/or external shapes. In addition, a low interference contour during gripping is desirable.

This object is achieved by a handling device according to claim 1.

The handling device is designed for handling objects, in particular for lifting, moving, lowering and setting down objects. The handling device comprises a manipulator, in particular a robot, and a coupling device having a coupling section for coupling an end effector to the manipulator. In particular, the manipulator is designed to displace the coupling device and an end effector option arranged thereon. The end effector may in particular be a gripping device, preferably a suction gripping device.

The manipulator comprises a spindle drive for driving a translational and/or rotational movement of the coupling device and an end effector optionally coupled thereto with respect to an, in particular vertical, Z axis. In this respect, the spindle drive is designed in particular to drive a translational positioning movement of the coupling device along the Z axis and/or to drive a rotational movement about the Z axis. In other words, the spindle drive is designed to displace the coupling device and an optionally arranged end effector thereon along the Z axis and/or about the Z axis.

The spindle drive comprises a spindle that is extended with a main longitudinal axis along the Z axis. In particular, the spindle is mounted rotatably about the Z axis, preferably in such a way that it may perform, in particular independently of one another, not only a rotational movement about the Z axis but also a translational movement along the Z axis. Preferably, the spindle is designed as a ball screw.

The coupling section of the coupling device is adjustable with respect to at least one degree of freedom relative to the spindle, in particular independently of a movement of the spindle. In particular, the coupling section may be pivotable relative to the spindle.

The handling device further comprises a drive device for driving a positioning movement of the coupling section with respect to the at least one degree of freedom. In this respect, the drive device is designed to move the coupling section with respect to the at least one degree of freedom relative to the spindle. In particular, the drive device may be designed to pivot the coupling section relative to the spindle.

The drive device comprises a drive unit (actuator) and a force transmission device for transmitting a drive movement of the drive unit to the coupling section.

The coupling device is arranged at a first end of the spindle, in particular fastened thereto. The drive unit of the drive device is arranged at the second, opposite end of the spindle, in particular fastened thereto.

Such a handling device makes it possible to adjust the coupling section and thus an end effector optionally arranged thereon in a simple and reliable manner relative to the spindle and to thus adapt an orientation of the end effector, for example, to a position and location of an object to be gripped as required. In this way, even objects in different positions and locations may be reliably gripped, which is in particular advantageous in “bin-picking,” wherein goods are regularly in disorder, i.e. with different orientations, in the storage container.

Due to the fact that the drive unit is fastened to the upper end of the spindle, an interference contour in the region of the end effector is reduced. This facilitates the gripping of objects from a storage container and, in particular, enables objects to be gripped from comparatively narrow storage containers or corner regions of a storage container. In addition, the proposed handling device minimizes the risk of objects getting caught on protrusions or recesses of the drive unit, thereby potentially damaging the drive unit or impairing its function. The handling device is designed to be particularly robust in this respect, so that reliable operation is ensured even after many gripping cycles in a storage container.

The at least one degree of freedom may be a linear (translational) and/or rotational degree of freedom. In this respect, it is conceivable that the coupling section may be translationally displaced and/or rotated relative to the spindle. Preferably, the degree of freedom is a pivot degree of freedom.

The force transmission device may comprise at least one force transmission element, which may be displaced along the Z axis and/or rotated about the Z axis. The at least one force transmission element may be, for example, a push rod, a Bowden cable, a toothed rack, or a spindle. In particular, the drive unit may be designed to drive a translational movement of the at least one force transmission element along the Z axis and/or a rotational movement of the at least one force transmission element about the Z axis.

The coupling device may have a connection section connected to the spindle, in particular in a rotationally fixed manner, and an adjustment section arranged movably thereon, in particular rotatably or pivotably, wherein the coupling section is arranged on the adjustment section. The drive device may then be configured to move the adjustment section relative to the connection section.

In particular, the coupling device may be designed to releasably connect an end effector to the manipulator in a repeatable manner. Preferably, the coupling section may be designed as a quick-change coupling. For example, it is conceivable that the coupling device comprises a magnetic connection, which is effective between the end effector and the coupling section. In this respect, only simple movement patterns are required for coupling or decoupling the end effector to or from the pivot portion, which favors an automatic end effector change.

In particular, the manipulator may be designed as a SCARA robot. In this respect, the manipulator may have a robot base and a robot arm, which has three elements arranged in sequence. In particular, it may be provided that a first element is connected to the robot base so as to be pivotable, in particular rotatable, about a first axis, a second element is connected to the first element so as to be pivotable, in particular rotatable, about a second axis, and a third element is provided by the spindle. In particular, the spindle is then rotatably connected to the second element about a third axis (the Z axis). Preferably, the first axis, the second axis and the third axis (Z axis) are parallel, preferably vertical, to one another. In particular, the second element may comprise a drive motor and/or optionally gearing devices of the spindle drive for driving a rotational movement of the spindle about the Z axis. The spindle is preferably designed as a ball screw.

Within the framework of an advantageous further development, the spindle may be designed as a hollow spindle. In this respect, the hollow spindle may comprise an internal, preferably central, hollow space. Preferably, the hollow space extends along the Z axis from the first end of the spindle to the second end of the spindle, in particular continuously. In this connection, it may be advantageous if the force transmission device is guided at least in sections through the hollow space of the hollow spindle. With such a design, an interference contour is further reduced during ripping. In addition, the force transmission device is protected from environmental influences, which reduces the risk of damage, in particular when “bin-picking” with a plurality of objects. In this respect, such an embodiment enables particularly reliable and trouble-free operation of the handling device.

The force transmission device may comprise at least one force transmission element, which is arranged at least in sections in the hollow space of the hollow spindle. In particular, the at least one force transmission element may extend from the first end of the spindle to the second end of the spindle along the Z axis. To transmit a drive movement of the drive unit to the coupling section, the at least one force transmission element may be displaced within the hollow space along the Z axis, in particular moved back and forth, and/or rotated about the Z axis.

It is conceivable that the force transmission element is a push rod. In particular, the push rod may be designed to transmit a translational movement along the Z axis and/or a rotational movement about the Z axis to the coupling section of the coupling device. It is also conceivable that the force transmission element is a Bowden cable. Alternatively, it is also conceivable that the force transmission element is designed as a toothed rack. Within the context of a further embodiment, it is also conceivable that the force transmission element is a spindle. The spindle of the drive unit may then be rotated about the Z axis, in particular relative to the spindle of the manipulator.

Within the context of an advantageous embodiment, the at least one degree of freedom may be a pivot degree of freedom. In particular, the coupling section may be pivotable relative to the spindle about a pivot axis, preferably orthogonally to the Z axis. The drive device may then be configured to drive a pivot movement of the coupling section about the pivot axis. By pivoting the coupling section, it is possible in particular to change an orientation of the end effector and thus to grip objects in different positions and locations in a simple manner.

Specifically, the coupling device may comprise a connection section for connecting the coupling device to the spindle and a pivot section, wherein the coupling section is arranged on the pivot section. The pivot section is then preferably mounted on the connection section so as to be pivotable about the pivot axis. In this connection, it can be advantageous if the pivot section can be pivoted continuously about the pivot axis. In particular, a maximum pivot angle of the pivot portion is between 0° and 90° inclusive, in particular 30°, further in particular 45°. In particular, the connection section may be connected to the spindle in a rotationally fixed manner.

In the case of an embodiment with a pivot section, the drive device is then configured in particular to drive a pivot movement of the pivot section about the pivot axis. In particular, the force transmission device may comprise at least one force transmission element that is mechanically coupled to the pivot section in such a way that a translational displacement movement of the at least one force transmission element along the Z axis leads to a pivot movement of the pivot section about the pivot axis. In this connection, it is conceivable, for example, that the at least one force transmission element, for example a push rod, is connected to the pivot section via a further pivot joint. With such an embodiment, it may be advantageous if the pivot axis between the force transmission element and the pivot section and the pivot axis between the connection section and the pivot section are parallel to one another.

For driving a displacement movement of the at least one force transmission element along the Z axis, it can be advantageous if the drive unit is designed as a linear drive for driving a translational movement along the Z axis. For example, the drive unit may comprise a pneumatic cylinder. Preferably, one axis of movement of the pneumatic cylinder is parallel or identical to the Z axis. It is also conceivable that the drive device comprises an electric cylinder and/or an electric drive with a lever.

Furthermore, the drive unit may optionally be designed to drive a rotational movement of the at least one force transmission element about the Z axis. For example, it is conceivable that the coupling section or the entire coupling device can be rotated about the Z axis relative to the spindle.

Within the context of a general aspect, it may also be advantageous if the coupling device is coupled to the spindle in a rotationally fixed manner about the Z axis, in particular via the connection section, so that a rotational movement of the spindle about the Z axis is transmitted to the coupling device and to an end effector optionally coupled thereto. Such an embodiment is particularly simple and robust in design, since no rotational movement about the Z axis needs to be provided by the drive device. In this connection, it is conceivable that the at least one force transmission element is coupled to the spindle in a rotationally fixed manner about the Z axis. This may be effected, for example, by the at least one force transmission element being connected to the coupling device in a rotationally fixed manner and the coupling device in turn being connected to the spindle in a rotationally fixed manner.

Furthermore, it proves advantageous if the drive unit is decoupled from a rotational movement of the spindle and/or of the at least one force transmission element about the Z axis. For example, it is conceivable that the drive unit is connected to the spindle via a pivot bearing upon a rotational movement of the spindle about the Z axis, the drive device is not rotated as well, but remains stationary. This has the advantage that supply connections of the drive unit, for example for connecting power cables or fluid lines, always point in the same direction, which makes possible an easy cable or hose routing. In this connection, it can also be advantageous if the drive unit is secured against rotation about the Z axis by a guide rod.

In the case of embodiments in which the at least one force transmission element is coupled to the spindle in a rotationally fixed manner about the Z axis, it can also be advantageous if the drive unit, in particular an actuator, for example a cylinder, connected to the at least one force transmission element, is decoupled from a rotational movement of the at least one force transmission element about the Z axis. For example, it is conceivable that the actuator is connected to the at least one force transmission element via a corresponding pivot bearing.

Within the context of a general aspect, it may be advantageous if a fluid supply, in particular a negative pressure supply and/or a positive pressure supply, is provided at the coupling device, for example in order to operate an end effector. In particular, it may be advantageous if the coupling section has a negative pressure outlet and/or a positive pressure outlet. The positive pressure outlet and/or the negative pressure outlet may, in particular, be designed in the form of a respective fluid interface for connection to a corresponding fluid counter-interface of an end effector. In this respect, the coupling section may be designed to establish a fluidic connection between the coupling device and the end effector. It may be particularly advantageous if the coupling device is designed so that at least one fluidic connection is formed between the coupling section and the end effector when the end effector is fastened to the coupling section, which makes possible the easy replacement of the end effector.

In this connection, it is also conceivable that the coupling section is designed to establish not only a negative pressure fluidic connection but also a positive pressure fluidic connection between the end effector and the coupling section. For example, it is possible that the coupling section has a negative pressure outlet and a positive pressure outlet and the end effector has a negative pressure inlet and or a positive pressure inlet on a corresponding counter-coupling side. It may be particularly advantageous if the negative pressure outlet and the negative pressure inlet, or the positive pressure outlet and the positive pressure inlet, respectively, are designed and arranged so that the negative pressure outlet and the negative pressure inlet, or the positive pressure outlet and the positive pressure inlet, respectively, form a fluidic connection when the end effector is fastened to the coupling section.

To supply the end effector with fluid, it can also be advantageous in the case of embodiments with a hollow spindle if at least one fluid feedthrough is provided for the passage of fluid, in particular negative pressure or positive pressure, through the hollow spindle. For example, it is conceivable that a fluid hose is guided within the hollow space of the hollow spindle. However, it is also conceivable that at least a partial volume of the hollow space of the hollow spindle itself provides the at least one fluid feedthrough. The fluid feedthrough does not constitute an interference contour when objects are being handled, as can be the case with external hose connections, for example.

In order to ensure a fluid supply to the end effector even during a pivot movement of the pivot section about the pivot axis, it may be advantageous in the case of embodiments of the coupling device with a pivot section if a fluidic connection between the fluid feedthrough and the negative pressure or positive pressure outlet, respectively, at the coupling section runs through the pivot joint.

Regardless of the specific embodiment of the handling device, the handling device may comprise a control device for controlling the manipulator and the drive device.

The handling device may further comprise a detection device, which is designed to detect the position and location of an object to be gripped, in particular the position and location of an outer surface of the object. This makes it possible, before the end effector approaches an object, to characterize the object, in particular to identify a gripping position on the object. For example, it is conceivable that the detection device comprises one or more cameras.

The control device may then be configured in particular to control the manipulator and/or the drive device as a function of an orientation, in particular position and location, of an object captured by the detection device.

As mentioned above, the end effector may be, in particular, a gripping device. For applications in the field of “bin-picking,” it has proven advantageous if the end effector is designed as a suction gripping device. In this respect, the handling device may comprise a suction gripping device, which is connected to the manipulator via the coupling section.

The invention is explained in more detail below with reference to the figures.

In the drawings:

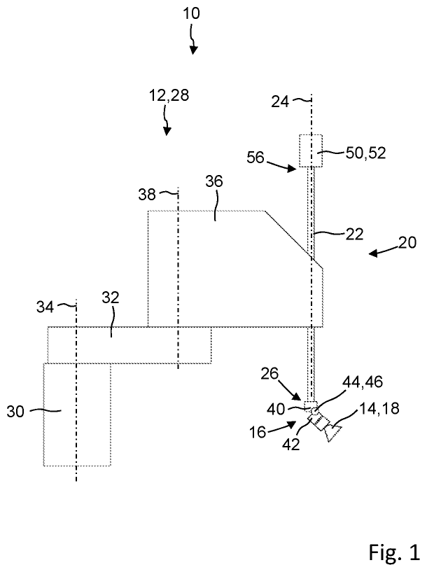

FIG. 1 shows a simplified schematic representation of an embodiment of the handling device in a side view; and

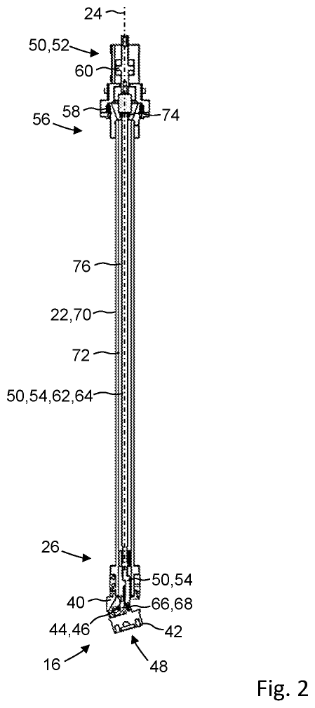

FIG. 2 shows an enlarged section of the handling device according to FIG. 1 in the region of the spindle in a sectional view.

In the following description and in the figures, identical reference signs are in each case used for identical or corresponding features.

FIG. 1 shows a simplified schematic representation of a handling device for gripping and handling objects (not shown), which is denoted as a whole by reference sign 10. The handling device 10 comprises a manipulator (for example, a robot) 12 and an end effector 14, which is connected to the manipulator 12 via a coupling device 16.

In the example shown, the end effector 14 is designed as a suction gripping device 18 for sucking up an object. However, in the case of embodiments not shown, it is also conceivable that the end effector 14 is designed as a mechanical gripper, for example as a pneumatically actuated mechanical gripper.

As shown schematically in FIG. 1, the manipulator 12 comprises a spindle drive 20 with a spindle 22, which extends along a Z axis 24. As shown in FIG. 1, the coupling device 16 is arranged at a first end 26 of the spindle 22 and may be translationally and/or rotationally displaced by the spindle 22 with respect to the Z axis 24.

Preferably, the spindle 22 is designed as a ball screw, which enables both a translational movement along the Z axis 24 and a purely rotational movement about the Z axis 24.

In the example shown, the manipulator 12 is designed as a 4-axis SCARA robot 28, wherein a third and fourth axis of the SCARA robot 28 (translational and rotational movement with respect to the Z axis 24) are provided by the spindle drive 20. In the specific example, the SCARA robot 28 comprises a robot base 30, to which a first robot element 32 fastened so as to be pivotable, in particular rotatable, about a first, in particular vertical, axis 34. A second robot element 36 is fastened to the first robot element 32 so as to be pivotable, in particular rotatable, about a second axis 38. The second robot element 36 then has the spindle 22 described above fastened to it. In particular, the second robot element 36 also comprises corresponding drive and/or gearing units of the spindle drive 20. By way of example and preferably, the first axis 34, the second axis 38 and the Z axis 24 (third axis) are arranged parallel to one another.

In the example shown, the coupling device 16 comprises a connection section 40 that is connected to the spindle 22, preferable in a rotationally fixed manner. The coupling device 16 further comprises a pivot section 42, which is connected to the connection section 40 via a pivot joint 44 and is thus pivotable about a pivot axis 46 relative to the spindle 22. By way of example, the pivot axis 46 is preferably oriented orthogonally to the Z axis 24 (see FIG. 1).

The pivot section 42 comprises a coupling section 48 to which the end effector 14 may be coupled, in particular in a repeatably releasable manner (see FIG. 2). In the coupled state, an orientation of the end effector 14 may then be changed by means of a pivot movement of the pivot section 42 about the pivot axis 46.

As mentioned above, the coupling section 48 may be designed as a quick-change coupling. For example, it is conceivable that the end effector 14 may be connected to the coupling section 48 via a magnetic connection.

The handling device 10 further comprises a drive device 50 for actuating a pivot movement of the pivot section 42, and thus the coupling section 48, about the pivot axis 46. The drive device 50 comprises a drive unit 52 and a force transmission device 54 for transmitting a drive movement of the drive unit 52 to the pivot section 42 (see FIG. 2).

The drive unit 52 is arranged at the second end 56 of the spindle 24 opposite the coupling device 16 (see FIG. 1). The drive unit 52 and the coupling device 16 are in this respect spatially separated from one another. Preferably, the drive unit 52 is mounted on the spindle 22 via a pivot bearing 58 and is thus decoupled from a rotational movement of the spindle 22 about the Z axis 24 (see FIG. 2).

As shown in FIG. 2, the drive unit 52 in the example shown comprises a pneumatic cylinder 60, which is designed to perform a translational movement along the Z axis 24. With embodiments not shown, it is also conceivable that the drive unit 52 has, for example, a cylinder driven by an electric motor.

In order to transmit a drive movement of the drive unit 52 or the pneumatic cylinder 60, respectively, to the pivot section 42, the force transmission device 54 comprises at least one force transmission element 62, which in the example shown is designed as a push rod 64 (see FIG. 2). In the case of embodiments not shown, it is also conceivable that the force transmission element 62 is designed as a Bowden cable, a toothed rack or a spindle.

As can be seen from FIG. 2, the push rod 64 is connected on the one hand to the pneumatic cylinder 60 and on the other hand to the pivot section 42. A coupling between the push rod 64 and the pivot section 42 is provided in such a way that a displacement movement of the push rod 64 along the Z axis 24 leads to a pivot movement of the pivot section 42 about the pivot axis 46.

For this purpose, the push rod 64 in the example is connected to the pivot section 42 via a pivot joint 66 so as to be pivotable about a pivot axis 68 (see FIG. 2). By way of example and most preferably, the pivot axis 46 between the connection section 40 and the pivot section 42 and a pivot axis 68 between the force transmission element 62 and the pivot section 42 are parallel to one another.

As shown by wav of example in FIG. 2, the force transmission device 54, in particular the force transmission element 62, is preferably guided in sections through the spindle 22. Specifically, the spindle 22 is designed as a hollow spindle 70, with a hollow space 72 extending along the Z axis 27 from the first end 26 to the second end 56.

In the example, the push rod 64 is arranged within the hollow space 72 and may be displaced back and forth along the Z axis 24. In the example shown, the push rod 64 is coupled in a rotationally fixed manner to the spindle 22 about the Z axis 24 via the coupling device 16. In an exemplary and preferred embodiment, the push rod 64 is then connected to the pneumatic cylinder 60 via a corresponding pivot bearing 74, so that the pneumatic cylinder 60 is decoupled from a rotational movement of the push rod about the Z axis 24.

As shown schematically in FIG. 2, the push rod 64 may preferably be dimensioned so that it does not completely fill the hollow space 72 of the hollow spindle 70; i.e., a partial volume of the hollow space 72 is free. This remaining partial volume of the hollow space may then optionally be used as a fluid feedthrough 76, for example to direct compressed air and/or negative pressure to the coupling device 16 and then to the end effector 14. In the case of embodiments not shown, it is also conceivable that a fluid hose is provided in the hollow space 72 for this purpose.

In order to supply the end effector 14 with fluid, in particular negative pressure and/or positive pressure, it may then be further advantageous if the coupling section 48 comprises a fluid interface (not shown) for connection to a corresponding fluid counter-interface of the end effector 14. Specifically, the coupling section 48 may have a negative pressure outlet and/or positive pressure outlet (not shown).

As mentioned above, the handling device 10 may optionally comprise a detection device (not shown), which is designed to detect the position and location of an object to be gripped.

In particular, the handling device 10 also comprises a control device (not shown) for controlling the manipulator 12 and the drive device 50. In particular, the control device may be configured to control the manipulator 12 and/or the drive device 50 as a function of a position and location of an object to be gripped, which is detected by the detection device.

1. Handling device (10), comprising
a manipulator (12), and a coupling device (16) having a coupling section (48) for coupling an end effector (14) to the manipulator (12), wherein
the manipulator (12) comprises a spindle drive (20) for driving a translational and/or rotational movement of the coupling device (16) and the end effector (14) coupled thereto with respect to a Z axis (24),
the spindle drive (20) comprises a spindle (22) extending along the Z axis (24),
the coupling section (48) is adjustable relative to the spindle (22) with respect to at least one degree of freedom,
a drive device (50) is provided for driving a positioning movement of the coupling section (48) with respect to the at least one degree of freedom,
the drive device (50) comprises a drive unit (52) and a force transmission device (54) for transmitting a driving movement of the drive unit (52) to the coupling section (48),
the coupling device (16) is arranged at a first end (26) of the spindle (22), and
the drive unit (52) is arranged at the second end (56) of the spindle (22).

2. Handling device (10) according to claim 1, wherein the spindle (22) is designed as a hollow spindle (70) with an inner hollow space (72), wherein the force transmission device (54) is guided at least in sections through the hollow space (72).

3. Handling device (10) according to claim 2, wherein the force transmission device (54) comprises at least one force transmission element (62), which is arranged at least in the sections in the hollow space (72) of the hollow spindle (70), and which either can be displaced in the hollow space (72) along the Z axis (24) or can be rotated about the Z axis (24).

4. Handling device (10) according to claim 3, wherein the at least one force transmission element (62) comprises a push rod (64), a Bowden cable, a rack, or a spindle.

5. Handling device (10) according to claim 3, wherein the coupling section (48) is pivotable relative to the spindle (22) about a pivot axis (46), including running orthogonally to the Z axis (24), wherein the drive device (50) is configured to drive a pivot movement of the coupling section (48) about the pivot axis (46).

6. Handling device (10) according to claim 5, wherein the coupling device (16) comprises a connection section (40) and a pivot section (42), wherein the connection section (40) is connected to the spindle (22), including in a rotationally fixed manner, wherein the pivot section (42) is mounted on the connection section (40) so as to be pivotable about the pivot axis (46), wherein the coupling section (48) is arranged on the pivot section (42).

7. Handling device (10) according to claim 6, wherein the at least one force transmission element (62) is mechanically coupled to the pivot section (42) in such a way that a displacement movement of the at least one force transmission element (62) along the Z axis (24) leads to a pivot movement of the pivot section (42) about the pivot axis (46).

8. Handling device (10) according to claim 1, wherein the drive unit (52) is designed as a linear drive, including a pneumatic cylinder (60).

9. Handling device (10) according to claim 1, wherein the coupling device (16) is coupled to the spindle (22) in a rotationally fixed manner.

10. Handling device (10) according to claim 1, wherein the drive unit (52) is decoupled from a rotational movement of either the spindle (22) and/or the at least one force transmission element (62) about the Z axis (24), including via correspondingly designed pivot bearings (58, 74).

11. Handling device (10) according to claim 1, wherein the coupling section (48) comprises a negative pressure outlet and/or a positive pressure outlet, including in the form of a fluid interface for connection to a corresponding fluid counter-interface of the end effector (14).

12. Handling device (10) according to claim 2, further comprising at least one fluid feedthrough (76) for guiding fluid, including using a negative pressure or positive pressure, through the hollow spindle (70).

13. Handling device (10) according to claim 1, further comprising:
a detection device, which is designed to detect the position and location of an object to be gripped; and
a control device, which is configured to control the manipulator (12) and/or the drive device (50) as a function of a position and/or location of an object detected by the detection device.

14. Handling device (10) according to claim 1, further comprising a suction gripping device (18), which is connected to the manipulator (12) via the coupling section (16).

15. Handling device (10) according to claim 2, wherein the drive unit (52) is designed as a linear drive, including a pneumatic cylinder (60).

16. Handling device (10) according to claim 2, wherein the coupling device (16) is coupled to the spindle (22) in a rotationally fixed manner.

17. Handling device (10) according to claim 2, wherein the drive unit (52) is decoupled from a rotational movement of either the spindle (22) and/or the at least one force transmission element (62) about the Z axis (24), including via correspondingly designed pivot bearings (58, 74).

18. Handling device (10) according to claim 2, wherein the coupling section (48) comprises a negative pressure outlet and/or a positive pressure outlet, including in the form of a fluid interface for connection to a corresponding fluid counter-interface of the end effector (14).

19. Handling device (10) according to claim 3, further comprising at least one fluid feedthrough (76) for guiding fluid, including using a negative pressure or positive pressure, through the hollow spindle (70).

20. Handling device (10) according to claim 2, further comprising:
a detection device, which is designed to detect the position and location of an object to be gripped; and
a control device, which is configured to control the manipulator (12) and/or the drive device (50) as a function of a position and/or location of an object detected by the detection device.
